(19) United States
(12) Patent Application Publication
(10) Pub. No.: US 2009/0089142 A1
(43) Pub. Date: Apr. 2, 2009

(54) Method and System for Configuring an Information Handling System for Online Content Feeds

(75) Inventors: Shannon Christopher Boesch, Austin, TX (US); Boon Kiat Law, Singapore (SG); Tapas Kumar Das, Singapore (SG)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/863,409

(22) Filed: Sep. 28, 2007

(51) Int. Cl. G06Q 30/00; G06F 17/30; G06Q 99/00; G06F 17/40

(52) U.S. Cl. 705/10; 705/1; 705/27

(57) ABSTRACT

Methods and systems configuring an information handling system for online content feeds are disclosed. A method may include determining, during an ordering process for an information handling system, whether a person ordering the information handling system desires to have the information handling system preconfigured to receive online content feeds. The method may also include, determining, during the ordering process, one or more desired online content feeds for which the person desires to have the information handling system preconfigured to receive. The method may further include preconfiguring the information handling system to receive the one or more desired online content feeds prior to delivery of the information handling system to an end user of the information handling system.

### TECHNICAL FIELD

The present disclosure relates in general to online content feeds, and more particularly configuration of information handling systems for online content feeds.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, online content feeds (also known as “web feeds”) have grown in popularity. Online content feeds allow software programs to check periodically for updates published on a web site or other online source. In the typical scenario of using online content feeds, a content provider publishes a link on their website which end users can register with an online content feed agent (also known as an “aggregator program,” a “feed reader,” or a “news reader”) running on their own information handling systems. After registration of a feed, the online content feed agent may communicate with the website or server hosting the feed. Thus, when instructed, the online content feed agent queries all the servers hosting a registered feed to determine if any feed has new content. If it is determined that new content exists, online content feed agent may either make a note of the new content or download it. In addition, online content feed agents may be scheduled to check for new content periodically. Often when websites provide web feeds to notify users of content updates, they only include summaries in the web feed rather than the full content itself.

The kinds of content delivered by an online content feed are typically website content in hypertext markup language (HTML) or links to web pages and/or other kinds of digital media, such as audio and/or video, for example. Online content feeds may be communicated in accordance with any suitable standard, format and/or protocol, including without limitation Rich Site Summary, RDF Site Summary, Really Simple Syndication (each of which are also known as “RSS”), and Atom Syndication Format.

Despite the growing popularity of online content feeds and the availability of information handling systems to support online content feeds, many users (particularly users that are not technically savvy) do not perform the necessary setup and configuration to receive online content feeds.

### SUMMARY

In accordance with the teachings of the present disclosure, the disadvantages and problems associated with data storage and backup have been substantially reduced or eliminated.

In accordance with one embodiment of the present disclosure, a method for configuring an information handling system for online content feeds is provided. The method may include determining, during an ordering process for an information handling system, whether a person ordering the information handling system desires to have the information handling system preconfigured to receive online content feeds. The method may also include, determining, during the ordering process, one or more desired online content feeds for which the person desires to have the information handling system preconfigured to receive. The method may further include preconfiguring the information handling system to receive the one or more desired online content feeds prior to delivery of the information handling system to an end user of the information handling system.

In accordance with another embodiment of the present invention, a method for configuring an information handling system for online content feeds is provided. The method may include presenting, during an ordering process for an information handling system, one or more available online content feeds to a person ordering an information handling system, the one or more available online content feeds presented in accordance with a popularity index for each of the one or more available online content feeds. The method may also include receiving, during the ordering process, a selection of one or more desired online content feeds from the one or more available online content feeds presented to the person. The method may further include preconfiguring the information handling system to receive the one or more desired online content feeds prior to delivery of the information handling system to an end user of the information handling system.

According to a further embodiment of the present disclosure, a system for configuring an information handling system for online content feeds may include a configuration server, a user device and a production module. The configuration server may be configured to present, during an ordering process for an information handling system, one or more available online content feeds to a person ordering an information handling system, the one or more available online content feeds presented in accordance with a popularity index for each of the one or more available online content feeds. The user device may be configured to communicate, during the ordering process, a selection of one or more desired online content feeds for which the person desires to have the information handling system preconfigured to receive. The production module may be configured to preconfigure, prior to delivery of the information handling system to an end user of the information handling system, the information handling system to receive the one or more desired online content feeds.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for ordering an information handling system preconfigured for online content feeds, in accordance with the present disclosure;

FIG. 2 illustrates a flow chart of an example method for ordering an information handling system preconfigured for online content feeds, in accordance with the present disclosure;

FIG. 3 illustrates a block diagram of an example system for receiving online content feeds, in accordance with the present disclosure;

FIG. 4 illustrates a flow chart of an example method for enabling online content feed capability on an information handling system, in accordance with the present disclosure;

FIG. 5 illustrates a flow chart of an example method for downloading new content via an online content feed, in accordance with the present disclosure;

FIG. 6 illustrates a flow chart of an example method for changing an online content feed configuration, in accordance with the present disclosure; and

FIG. 7 illustrates a flow chart of an example method for updating popularity indexes related to an online content feed, in accordance with the present disclosure.

### DETAILED DESCRIPTION

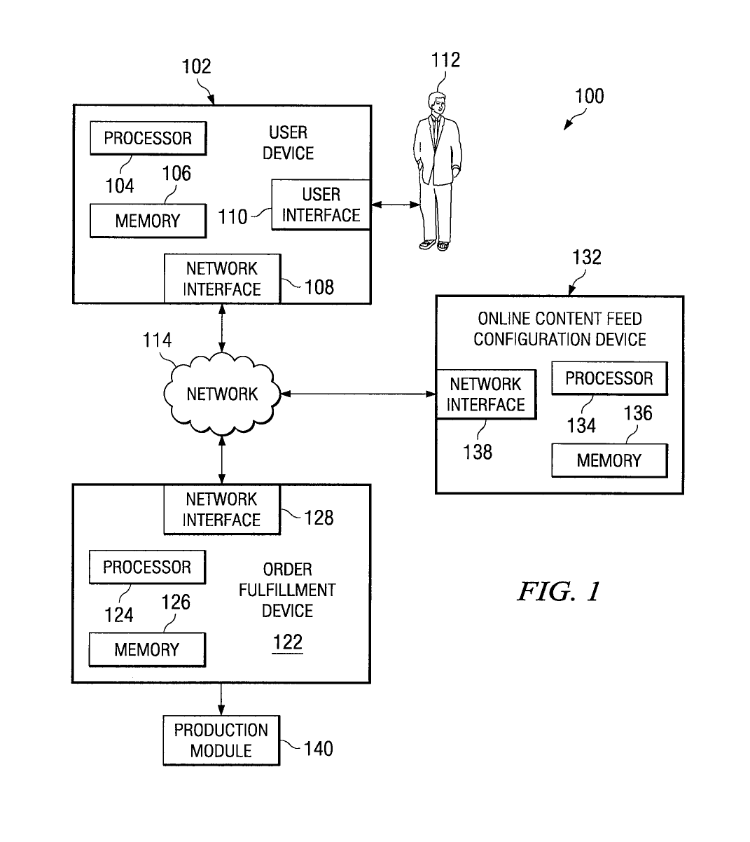

Preferred embodiments and their advantages are best understood by reference to FIGS. 1 through 7, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

In addition, for the purposes of this disclosure, tangible computer readable media may include any instrumentality or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or physical or virtual storage resources.

FIG. 1 illustrates a block diagram of an example system 100 for ordering an information handling system preconfigured for online content feeds, in accordance with the present disclosure. As depicted in FIG. 1, system 100 may include a user device 102, a network 114, an order fulfillment device 122, an online content feed configuration server 132, and a production module 140.

User device 102 may comprise an information handling system and may generally be operable to receive data from and/or communicate data to one or more other information handling systems via network 114. In certain embodiments, user device 102 may be a server. In another embodiment, user device 102 may be a personal computer. As depicted in FIG. 1, user device 102 may comprise a processor 104, a memory 106 communicatively coupled to processor 104, a network interface 108 communicatively coupled to processor 104, and a user interface 110 coupled to processor 104.

Processor 104 may comprise any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 104 may interpret and/or execute program instructions and/or process data stored in memory 106 and/or another component of user device 102.

Memory 106 may be communicatively coupled to processor 104 and may comprise any system, device, or apparatus operable to retain program instructions or data for a period of time. Memory 106 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to user device 102 is turned off.

Network interface 108 may be any suitable system, apparatus, or device operable to serve as an interface between user device 102 and network 114. Network interface 108 may enable user device 102 to communicate over network 114 using any suitable transmission protocol and/or standard, including without limitation all transmission protocols and/or standards enumerated below with respect to the discussion of network 114.

User interface 110 may comprise any instrumentality or aggregation of instrumentalities by which person 112 may interact with user device 102. For example, user interface 110 may permit person 112 to input data and/or instructions into user device 102 (e.g., via a keyboard, pointing device, and/or other suitable means), and/or otherwise manipulate user device 102 and its associated components. User interface 110 may also permit user device 102 to communicate data to person 112, e.g., by means of a display device.

Network 114 may be a network and/or fabric configured to couple user device 102 to order fulfillment device 122 and online content feed configuration server 132. Network 11 114 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data), or any combination thereof. Network 114 may transmit data using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof. Network 114 and its various components may be implemented using hardware, software, or any combination thereof.

Order fulfillment device 122 may comprise an information handling system and may generally be operable to receive data from and/or communicate data to one or more other information handling systems via network 114. In certain embodiments, order fulfillment device 122 may be a server. As depicted in FIG. 1, order fulfillment device 122 may comprise a processor 124, a memory 126 communicatively coupled to processor 124, and a network interface 128 communicatively coupled to processor 124.

Processor 124 may comprise any system, device, or apparatus operable to interpret and/or execute program instructions and/or process data, and may include, without limitation, a microprocessor, microcontroller, DSP, ASIC, or any other digital or analog circuitry configured to interpret and/or execute program instructions and/or process data. In some embodiments, processor 124 may interpret and/or execute program instructions and/or process data stored in memory 126 and/or another component of order fulfillment device 122.

Memory 126 may be communicatively coupled to processor 124 and may comprise any system, device, or apparatus operable to retain program instructions or data for a period of time. Memory 126 may comprise RAM, EEPROM, a PCMCIA card, flash memory, magnetic storage, opto-magnetic storage, or any suitable selection and/or array of volatile or non-volatile memory that retains data after power to order fulfillment device 122 is turned off.

Network interface 128 may be any suitable system, apparatus, or device operable to serve as an interface between order fulfillment device 122 and network 114. Network interface 128 may enable order fulfillment device 122 to communicate over network 114 using any suitable transmission protocol and/or standard, including without limitation all transmission protocols and/or standards enumerated above with respect to the discussion of network 114.

Order fulfillment device 122 may comprise an information handling system and may generally be operable to receive data from and/or communicate data to one or more other information handling systems via network 114. In certain embodiments, order fulfillment device 122 may be a server. As depicted in FIG. 1, order fulfillment device 122 may comprise a processor 124, a memory 126 communicatively coupled to processor 124, and a network interface 128 communicatively coupled to processor 124.

Processor 124 may comprise any system, device, or apparatus operable to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 124 may interpret and/or execute program instructions and/or process data stored in memory 126 and/or another component of order fulfillment device 122.

Memory 126 may be communicatively coupled to processor 124 and may comprise any system, device, or apparatus operable to retain program instructions or data for a period of time. Memory 126 may comprise RAM, EEPROM, a PCMCIA card, flash memory, magnetic storage, opto-magnetic storage, or any suitable selection and/or array of volatile or non-volatile memory that retains data after power to order fulfillment device 122 is turned off.

Network interface 128 may be any suitable system, apparatus, or device operable to serve as an interface between order fulfillment device 122 and network 114. Network interface 128 may enable order fulfillment device 122 to communicate over network 114 using any suitable transmission protocol and/or standard, including without limitation all transmission protocols and/or standards enumerated above with respect to the discussion of network 114.

Online content feed configuration device 132 may comprise an information handling system and may generally be operable to receive data from and/or communicate data to one or more other information handling systems via network 114. In certain embodiments, online content feed configuration device 132 may be a server. As depicted in FIG. 1, online content feed configuration device 132 may comprise a processor 134, a memory 136 communicatively coupled to processor 134, and a network interface 138 communicatively coupled to processor 134.

Processor 134 may comprise any system, device, or apparatus operable to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 134 may interpret and/or execute program instructions and/or process data stored in memory 136 and/or another component of online content feed configuration device 132.

Memory 136 may be communicatively coupled to processor 134 and may comprise any system, device, or apparatus operable to retain program instructions or data for a period of time. Memory 136 may comprise RAM, EEPROM, a PCMCIA card, flash memory, magnetic storage, opto-magnetic storage, or any suitable selection and/or array of volatile or non-volatile memory that retains data after power to online content feed configuration device 132 is turned off.

Network interface 138 may be any suitable system, apparatus, or device operable to serve as an interface between online content feed configuration device 132 and network 114. Network interface 138 may enable online content feed configuration device 132 to communicate over network 114 using any suitable transmission protocol and/or standard, including without limitation all transmission protocols and/or standards enumerated above with respect to the discussion of network 114.

Production module 140 may be any instrumentality or aggregation of instrumentalities operable to manufacture an information handling system in accordance with data and/or instructions received from order fulfillment device 122.

In operation, person 112 may use user device 102 to initiate an order for an information handling system. For example, person 112 may use user device 102 to access an information handling system manufacturer and/or vendor website via network 114 or otherwise. In certain embodiments, the website may execute in whole or part on, and/or communicate with, order fulfillment device 122. The accessed website may include one or more forms permitting person 112 to select and/or input desired selections for various software and/or hardware components that person 112 desires (e.g., desired operating system, processor, memory capacity, office productivity suite, hard drive capacity, networking interfaces, etc.). In addition, during the ordering process, the accessed website may query person 112 whether person 112 desires to have the information handling system being ordered to be preconfigured to receive online content feeds and/or query person 112 to select desired online content feeds.

Person 112's order, including desired selections for system components and online content feeds, may be communicated to order fulfillment device 122 and online content feed configuration device 132. Order fulfillment device 122 may communicate instructions and/or data associated with person 112's order to production module 140, which may manufacture and/or configure an information handling system in accordance with person 112's order.

Online content feed configuration device 132 may receive instructions and/or data associated with person 112's desired selections for receiving online content feeds. Such instructions and/or data may be aggregated with existing instructions and/or data associated with previous orders for information handling systems. Online content feed configuration device 132 may use such collected instructions and/or data to track and/or monitor the most popular online content feeds. In addition, such collected instructions and/or data can be used to assist person 112 during an online ordering process, for example to present person 112 with information regarding the most popular online content feeds to aid in person 112's selection of desired online content feeds, as described in greater detail below.

Although system 100 is depicted as having one user device 102, one order fulfillment device 122, one online content configuration device 132, and one production module 140, system 100 may include any number of user devices 102, order fulfillment devices 122, online content configuration devices 132, and/or production modules 140.

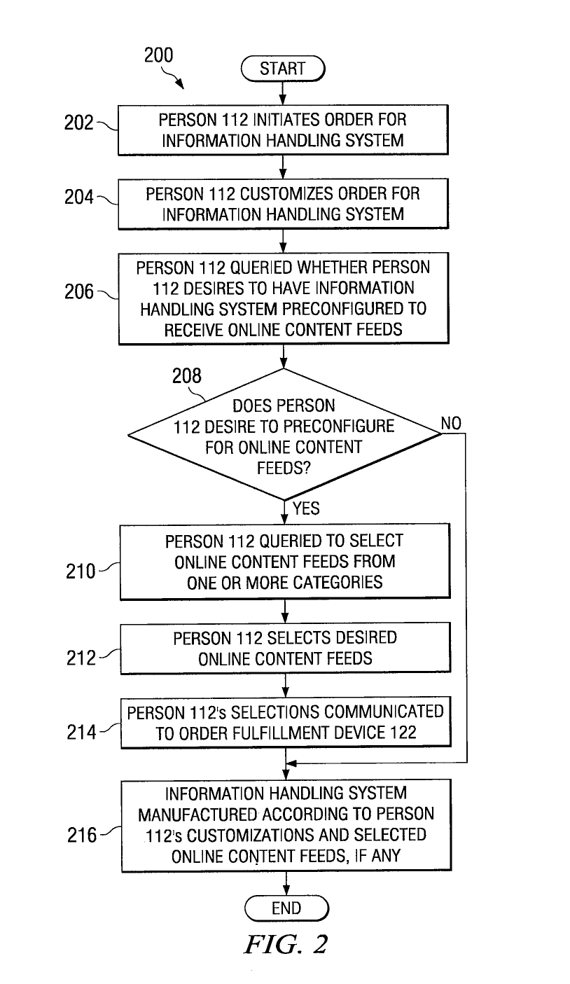

FIG. 2 illustrates a flow chart of an example method 200 for ordering an information handling system preconfigured for online content feeds, in accordance with the present disclosure. In one embodiment, method 200 includes receiving desired selections of online content feeds from a person and manufacturing an information handling system in accordance with such selections.

According to one embodiment, method 200 preferably begins at step 202. As noted above, teachings of the present disclosure may be implemented in a variety of configurations of system 100. As such, the preferred initialization point for method 200 and the order of the steps 202-216 comprising method 200 may depend on the implementation chosen.

At step 202, person 112 may initiate an order for an information handling system. For example, in some embodiments, person 112 may use user device 102 to access a website for online ordering of an information handling system from a manufacturer and/or vendor. In some embodiments, the accessed website may execute in whole or part on, and/or communicate with, order fulfillment device 122. In another embodiment, person 112 may initiate an order by contacting a computer manufacturer and/or vendor via telephone and/or any other suitable means.

At step 204, person 112 may customize his or her order for an information handling system. For example, if ordering an information handling system via a website, person 112 may customize various components to be included in the information handling system (e.g., desired operating system, processor, memory capacity, office productivity suite, hard drive capacity, networking interfaces, etc.) by inputting appropriate information into one or more fields of a web application. If ordering via telephone, an operator or automated telephone system may query person 112 regarding his or her desired selections, and person 112 may answer questions orally and/or using a physical interface provided on the telephone.

At step 206, person 112 may be queried whether the ordered information handling system should be preconfigured to receive online content feeds. For example, an online information handling system ordering website may communicate a question to person 112 asking person 112 whether they want to have the information handling system preconfigured to receive online content feeds. Person 112 may respond to the question in any suitable manner, including without limitation, typing “yes” or “no,” selecting a button and/or a checkbox, and/or selecting an answer from a drop-down list. If an order is being placed via telephone, an operator or automated telephone system may ask person 112 whether person 112 desires to have the ordered information handling system preconfigured to receive online content feeds, and person 112 may answer orally and/or using a physical interface provided on the telephone.

At step 208, order fulfillment device 122 and/or another component of system 100 may determine whether person 112 wants the ordered information handling system preconfigured to receive online content feeds. If person 112 does not want the information handling system preconfigured to receive online content feeds, method 200 may proceed to step 216 where the information handling system will be manufactured without preconfiguration for receiving online content feeds. Otherwise, if person 112 wants the information handling system preconfigured to receive online content feeds, method 200 may proceed to step 210.

At step 210, person 112 may be queried to select one or more online content feeds from one or more categories. For example, if ordering via a website, person 112 may be presented with one or more categories of online content feeds (e.g., U.S. news, world news, politics, health, entertainment, computing, sports, finance, etc.), each category listing one or more online content feeds particular to the category. In some embodiments, online content feeds may be organized in accordance with a “popularity index” or score, wherein the popularity index or score for each online may be based at least on a number of subscribers to the particular online content feed. The popularity index may be based at least one or more demographic characteristics of person 112 and a number of subscribers to the particular syndicated online feed that possess the one or more demographic characteristics (e.g., at least one of the person's age, sex, race, nationality, and geographic location). In the same or alternative embodiments, the popularity index for each one of the one or more online content feeds may be determined based at least on one or more characteristics of the information handling system (e.g., model, operating system, peripherals, and/or other system components) and/or a number of subscribers to the particular online feed that have ordered an information handling system possessing the one or more characteristics.

At step 212, person 112 may select one or more desired content feeds. For example, person 112 may select one or more content feeds any suitable manner, including without limitation, selecting one or more buttons and/or checkboxes, and/or selecting one or more answers from drop-down lists. If an order is being placed via telephone, an operator or automated telephone system may list available online content feeds and person 112 may communicate his or her selections orally and/or using a physical interface provided on the telephone.

At step 214, person 112's selections may be communicated to order fulfillment device 122. At step 216, order fulfillment device may communicate instructions and/or data regarding person 112's order to production module 140, which in turn may manufacture the ordered information handling system according to person 112's customizations and selected online content feeds, if any. After completion of step 216, method 200 may end.

Although FIG. 2 discloses a particular number of steps to be taken with respect to method 200, it is understood that method 200 may be executed with greater or lesser steps than those depicted in FIG. 2. For example, in certain embodiments, person 112 may not initiate an order for an information handling system, as shown in step 202. Instead, person 112 may be solicited or “cold called” to order an information handling system. In the same or alternative embodiments, the configuration of selected online content feeds at steps 210 to step 214 may occur after an information handling system has been ordered and received by the intended end user. In addition, although FIG. 2 discloses a certain order of steps to be taken with respect to method 200, the steps comprising method 200 may be completed in any suitable order. For example, in certain embodiments, step 206 may occur prior to step 204.

Method 200 may be implemented using system 100 or any other system operable to implement method 200. In certain embodiments, method 200 may be implemented partially or fully in software embodied in tangible computer readable media.

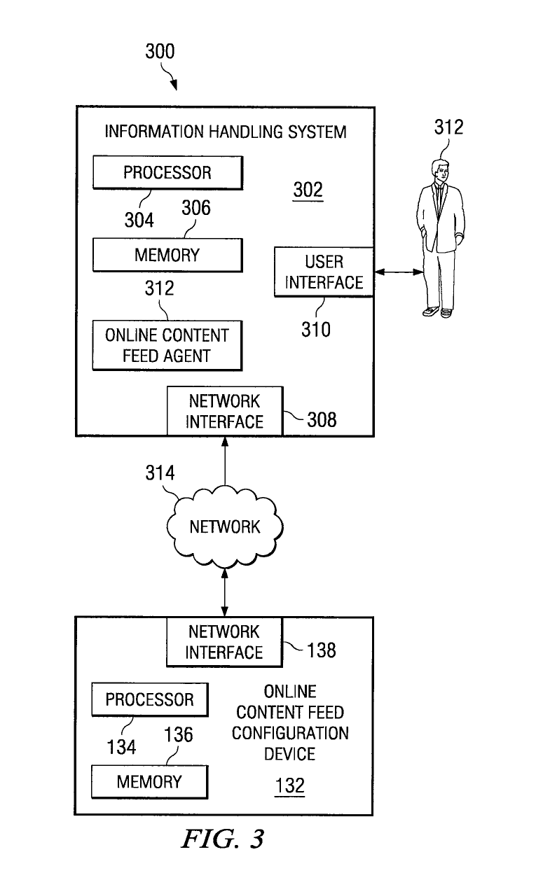

FIG. 3 illustrates a block diagram of an example system 300 for receiving online content feeds, in accordance with the present disclosure. As depicted in FIG. 1, system 300 may comprise information handling system 302, network 314, and online content feed configuration device 132.

Information handling system 302 may comprise an information handling system manufactured and/or configured in whole or part using system 100 and/or method 200. In certain embodiments, information handling system 302 may be a server. In another embodiment, information handling system 302 may be a personal computer. As depicted in FIG. 3, information handling system 302 may comprise a processor 304, a memory 306 communicatively coupled to processor 304, a network interface 308 communicatively coupled to processor 304, a user interface 310 coupled to processor 304, and an online content feed agent 311 coupled to processor 304.

Processor 304 may comprise any system, device, or apparatus operable to interpret and/or execute program instructions and/or process data, and may include, without limitation a microprocessor, microcontroller, DSP, ASIC, or any other digital or analog circuitry configured to interpret and/or execute program instructions and/or process data. In some embodiments, processor 304 may interpret and/or execute program instructions and/or process data stored in memory 306 and/or another component of information handling system 302.

Memory 306 may be communicatively coupled to processor 304 and may comprise any system, device, or apparatus operable to retain program instructions or data for a period of time. Memory 306 may comprise RAM, EEPROM, a PCMCIA card, flash memory, magnetic storage, opto-magnetic storage, or any suitable selection and/or array of volatile or non-volatile memory that retains data after power to information handling system 302 is turned off.

Network interface 308 may be any suitable system, apparatus, or device operable to serve as an interface between information handling system 302 and network 314. Network interface 308 may enable order information handling system to communicate over network 314 using any suitable transmission protocol and/or standard, including without limitation all transmission protocols and/or standards enumerated below with respect to the discussion of network 314.

User interface 310 may comprise any instrumentality or aggregation of instrumentalities by which person 312 may interact with information handling system 302. For example, user interface 310 may permit person 312 to input data and/or instructions into information handling system 302 (e.g., via a keyboard, pointing device, and/or other suitable means), and/or otherwise manipulate information handling system 302 and its associated components. User interface 310 may also permit information handling system 302 to communicate data to person 312, e.g. by means of a display monitor.

Network 314 may be a network and/or fabric configured to couple information handling system 302 to online content feed configuration server 132. Network 314 may be implemented as, or may be a part of, a SAN, a PAN, a LAN, a MAN, a WAN, a WLAN, a VPN, an intranet, the Internet or any other appropriate architecture or system that facilitates the communication of signals, data and/or messages (generally referred to as data), or any combination thereof. Network 314 may transmit data using any storage and/or communication protocol, including without limitation, Fibre Channel, Frame Relay, ATM, IP, other packet-based protocol, SCSI, iSCSI, ATA, SATA, ATAPI, SSA, IDE, and/or any combination thereof. Network 314 and its various components may be implemented using hardware, software, or any combination thereof. In certain embodiments, network 114 may be identical or substantially similar to network 114 depicted in FIG. 1.

Online content feed agent 311 may be any system, device, apparatus, computer program, or any combination thereof operable to manage and download the receipt of online content feeds at information handling system 302. For example, agent 311 may be configured to determine from time-to-time whether a particular online content feed has new content. In some embodiments, agent 311 may be configured to notify person 312 of new online content feed content and/or download new content to information handling system 302. Agent 311 may also permit person 312 to interact with agent 311 in order to allow person 312 to create and/or modify online content feed configurations (e.g., change, modify, and/or update feeds to which person 312 subscribed). In certain embodiments, agent 311 may comprise a program of instructions embodied in tangible computer readable media and executable on processor 304.

In operation, online content feed agent 311 may be preconfigured to receive online content feeds. For example, online content feed agent 311 may periodically monitor for new content of selected content feeds, and download such new content. In addition, person 312 may access online content feed agent 311 to view such new content and/or modify the configuration of online content feeds received at information handling system 302. Online content feed configuration device 132 may communicate with information handling system 302 (and other information handling systems 302) to determine the numbers of subscribers to one or more online content feeds, and accordingly update popularity indexes associated with each online content feed.

Although system 300 is depicted as having one information handling system 302 and one online content configuration device 132, system 300 may include any number of information handling systems 302 and online content configuration devices 132. In addition, although system 300 is depicted as comprising online content feed configuration device which is also depicted as part of system 100 in FIG. 1, the online content configuration device 132 of system 300 may be different than the online content configuration device of system 100.

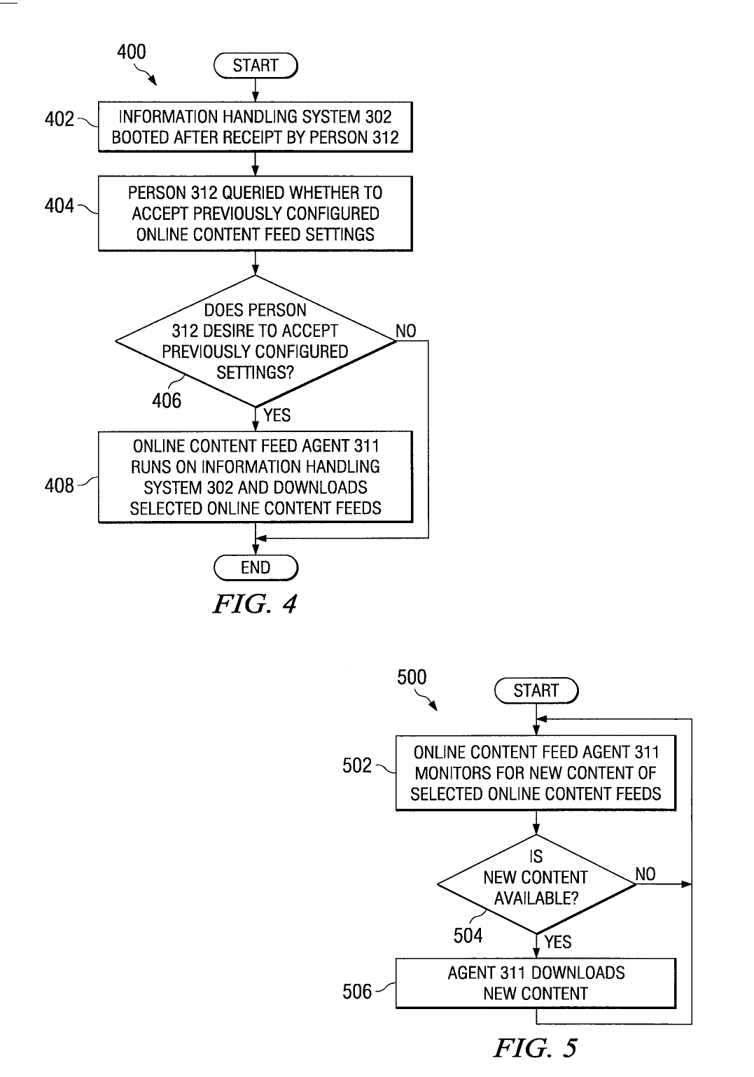

FIG. 4 illustrates a flow chart of an example method 400 for enabling online content feed capability on information handling system 302, in accordance with the present disclosure. In one embodiment, method 400 includes querying person 312 whether to accept previously configured online content feed settings and downloading online content feeds to information handling system 300 in response to person 312's acceptance of previously configured settings.

According to one embodiment, method 400 preferably begins at step 402. As noted above, teachings of the present disclosure may be implemented in a variety of configurations of system 300. As such, the preferred initialization point for method 400 and the order of the steps 402-408 comprising method 400 may depend on the implementation chosen.

At step 402, person 312 may boot information handling system 302 after receiving or having information handling system 302 delivered. At step 404, person 312 may be queried whether to accept the online content feed settings previously configured pursuant to method 200. For example, person 312 may be presented, via user interface 310, with a dialog box that queries person 312 whether they want to accept the settings. In certain embodiments person 312 may be presented with an option to defer the decision to accept or reject the settings. In such embodiments, person 312 may be queried at a later time whether to accept the previously configured settings.

At step 406, agent 311 and/or another component of system 300 determines whether person 312 desires to accept the previously configured online content feed settings. If person 312 does not accept the previously configured settings, method 400 may end. In other embodiments, in response to a determination that user 312 does not accept the previously configured settings, user 312 may be queried whether or not they wish to configure information handling system 302 for receipt of online content feeds, and may be given an opportunity to configure system 302 for receipt of online content feeds in a manner similar to that depicted at steps 210-214 of method 200.

If it is determined that person 312 desires to accept the previously configured online content feed settings, method 400 may proceed to step 408. At step 408, online content feed agent 311 running on information handling system 302 may download selected online content feeds to information handling system 302. After completion of step 408, method 400 may end.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order. Method 400 may be implemented using system 300 or any other system operable to implement method 400. In certain embodiments, method 400 may be implemented partially or fully in software embodied in tangible computer readable media.

FIG. 5 illustrates a flow chart of an example method 500 for the downloading of new content via an online content feed, in accordance with the present disclosure. In one embodiment, method 500 includes monitoring for new content of selected online content feeds and downloading such new content.

According to one embodiment, method 500 preferably begins at step 502. As noted above, teachings of the present disclosure may be implemented in a variety of configurations of system 300. As such, the preferred initialization point for method 500 and the order of the steps 502-506 comprising method 500 may depend on the implementation chosen.

At step 502, online content feed agent 311 may monitor for new content of online content feeds to which person 312 and/or information handling system 302 is subscribed. If agent 311 determines at step 504 that new content is available, method 500 may proceed to step 506. Otherwise, if new content is not available, method 500 may proceed again to step 502 where agent 311 may continue to monitor for new content. At step 506, agent 311 may download new content from the subscribed-to online content feeds. After completion of step 506, method 500 may again proceed to step 502, where agent 311 may continue to monitor for new content.

Although FIG. 5 discloses a particular number of steps to be taken with respect to method 500, method 500 may be executed with greater or lesser steps than those depicted in FIG. 5. For example, in certain embodiments of method 500, agent 311 may also download updated popularity index information and query person 312 whether to subscribe to additional online content feeds. In addition, although FIG. 5 discloses a certain order of steps to be taken with respect to method 500, the steps comprising method 500 may be completed in any suitable order. Method 500 may be implemented using system 300 or any other system operable to implement method 500. In certain embodiments, method 500 may be implemented partially or fully in software embodied in tangible computer readable media.

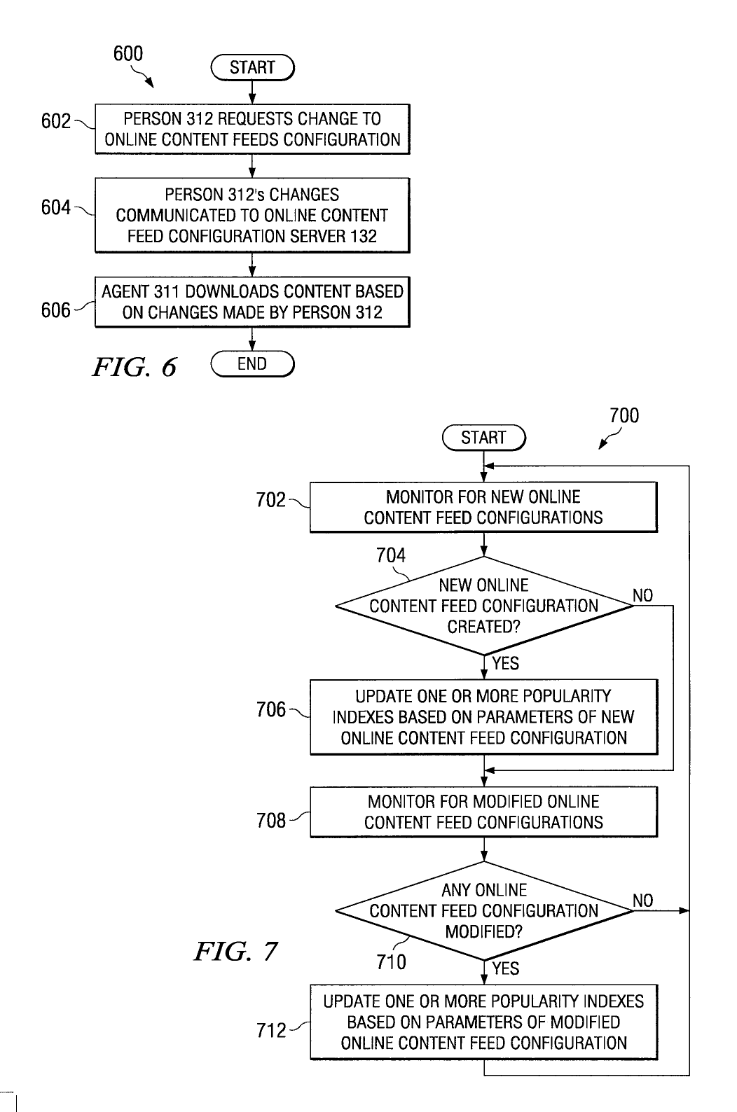

FIG. 6 illustrates a flow chart of an example method 600 for changing an online content feed configuration, in accordance with the present disclosure. In one embodiment, method 600 includes monitoring for new content of selected online content feeds and downloading such new content.

According to one embodiment, method 600 preferably begins at step 602. As noted above, teachings of the present disclosure may be implemented in a variety of configurations of system 300. As such, the preferred initialization point for method 600 and the order of the steps 602-606 comprising method 600 may depend on the implementation chosen.

At step 602, person 312 may request a change to the configuration for receiving online content feeds at information handling system 302. For example, via user interface 310, person 312 may instruct agent 311 to modify configuration settings to subscribe to currently unsubscribed-to online content feeds and/or unsubscribe to currently subscribed-to online content feeds.

At step 604, person 312's desired modifications may be communicated to online feed configuration server 132, in order to allow configuration server 132 to update popularity indexes of available online content feeds, in accordance with the present disclosure. At step 606, agent 311 may download online content based on the configuration modifications made by person 312. For example, if person 312 subscribed to a previously unsubscribed-to online content feed, agent 311 may download content associated with the newly subscribed-to feed. After completion of step 606, method 600 may end.

Although FIG. 6 discloses a particular number of steps to be taken with respect to method 600, method 600 may be executed with greater or lesser steps than those depicted in FIG. 6. For example, in certain embodiments, after step 602, person 312 may be queried with one or more content feeds from one or more categories and/or organized based on a popularity index. As another example, in the same or alternative embodiments, agent 311 may be configured to automatically update the online content feeds configuration by subscribing to previously-unsubscribed content feeds which are deemed popular according to one or more popularity indexes.

In addition, although FIG. 6 discloses a certain order of steps to be taken with respect to method 600, the steps comprising method 600 may be completed in any suitable order. Method 600 may be implemented using system 300 or any other system operable to implement method 600. In certain embodiments, method 600 may be implemented partially or fully in software embodied in tangible computer readable media.

FIG. 7 illustrates a flow chart of an example method 700 for updating popularity indexes related to an online content feed, in accordance with the present disclosure. In one embodiment, method 700 includes monitoring for new or modified online content feed configurations of information handling systems 302 and updating one or more popularity indexes based on parameters of the new or modified online content feed configuration.

According to one embodiment, method 700 preferably begins at step 702. As noted above, teachings of the present disclosure may be implemented in a variety of configurations of system 300. As such, the preferred initialization point for method 700 and the order of the steps 702-712 comprising method 700 may depend on the implementation chosen.

At step 702, online content feed configuration device 132 may monitor a plurality of information handling systems 302 for new online content feed configurations. For example, online content feed configuration device 132 may monitor for the creation of new online content feed configurations created when person 112 orders an information handling system and preconfigures the information handling system for receiving online content feeds, in accordance with method 200.

At step 704, online content feed configuration device 132 may determine whether any new online content feed configurations have been created. If one or more new online content feeds have been created, method 700 may proceed to step 706. Otherwise, if no new online content feeds have been created, method 700 may proceed to step 708, where online content feed configuration device 132 may monitor for modified online content feed configurations.

At step 706, online content feed configuration device 132 may update one or more popularity indexes associated with online content feeds based on parameters of the new online content feed configurations. For example, if a person 112 orders an information handling system and preconfigures the information handling system for receiving online content feeds, online content feed configuration device 132 may update one or more popularity indexes based on the online content feeds selected by person 112, as well as demographic characteristics of person 112 and/or characteristics of the information handling system ordered.

At step 708, online content feed configuration device 132 may monitor a plurality of information handling systems 302 for modifications to existing online content feed configurations. For example, online content feed configuration device 132 may monitor for the modification of online content feed configurations, for example as depicted in method 600 of FIG. 6.

At step 710, online content feed configuration device 132 may determine whether any existing online content feed configurations have been modified. If one or more existing online content feeds have been modified, method 700 may proceed to step 712. Otherwise, if no existing online content feeds have been modified, method 700 may proceed again to step 702, where online content feed configuration device 132 may again monitor for new and modified online content feed configurations.

At step 712, online content feed configuration device 132 may update one or more popularity indexes associated with online content feeds based on parameters of the modified online content feed configurations. For example, if a person 312 modifies an existing online content configuration, online content feed configuration device 132 may update one or more popularity indexes based on the online content feeds subscribed to or unsubscribed to by person 312, and/or demographic characteristics of person 312, and/or characteristics of the information handling system 302 for which modifications have been made.

Although FIG. 7 discloses a particular number of steps to be taken with respect to method 700, method 700 may be executed with greater or lesser steps than those depicted in FIG. 7. In addition, although FIG. 7 discloses a certain order of steps to be taken with respect to method 700, the steps comprising method 700 may be completed in any suitable order. Method 700 may be implemented using system 300 or any other system operable to implement method 700. In certain embodiments, method 700 may be implemented partially or fully in software embodied in tangible computer readable media.

Using the methods and systems disclosed herein, problems associated with conventional approaches for configuration of an information handling system for receiving online content feeds have been reduced or eliminated. For example, persons may now be given the option to have information handling systems preconfigured for receiving online content feeds, thereby reducing or eliminating some or all of the user setup and configuration necessary to receive online content feeds. In addition, the use of popularity indexes to assist persons in selecting online content feeds which to subscribe may also reduce or eliminate problems associated with conventional approaches for configuration of an information handling system for receiving online content feeds.

Although the present disclosure has been described in detail, it should be understood that various changes, substitutions, and alterations can be made hereto without departing from the spirit and the scope of the disclosure as defined by the appended claims.

What is claimed is:

1. A method for configuring an information handling system for online content feeds, comprising:
during an ordering process for an information handling system, determining whether a person ordering the information handling system desires to have the information handling system preconfigured to receive online content feeds;
during the ordering process, determining one or more desired online content feeds for which the person desires to have the information handling system preconfigured to receive; and
prior to delivery of the information handling system to an end user of the information handling system, preconfiguring the information handling system to receive the one or more desired online content feeds.

2. A method according to claim 1, wherein determining the one or more desired online content feeds includes querying the person to select the one or more desired online content feeds from one or more available online content feeds.

3. A method according to claim 2, wherein querying the person to select the one or more desired online content feeds includes presenting the one or more available online content feeds to the person in accordance with a popularity index for each of the one or more available online content feeds.

4. A method according to claim 3, wherein the popularity index for each of the one or more available online content feeds is determined based at least on a number of subscribers to the particular online content feed.

5. A method according to claim 3, wherein the popularity index for each one of the one or more available online content feeds is determined based at least on:
one or more demographic characteristics of the person; and
a number of subscribers to the particular online feed that possess the one or more demographic characteristics.

6. A method according to claim 5, wherein the one or more demographic characteristics include at least one of the person's age, sex, race, nationality, and geographic location.

7. A method according to claim 3, wherein the popularity index for each one of the one or more available online content feeds is determined based at least on:
one or more characteristics of the information handling system; and
a number of subscribers to the particular online feed that have ordered an information handling system possessing the one or more characteristics.

8. A method according to claim 3, further comprising:
after delivery of the information handling system to the end user of the information handling system, presenting one or more additional available content feeds to the person in accordance with the popularity index for each of the one or more additional available content feeds, wherein the one or more additional available online content feeds do not include the one or more additional available online content feeds; and
querying the end user to select one or more additional available online content feeds.

9. A method for configuring an information handling system for online content feeds, comprising:
during an ordering process for an information handling system, presenting one or more available online content feeds to a person ordering an information handling system, the one or more available online content feeds presented in accordance with a popularity index for each of the one or more available online content feeds;
during the ordering process, receiving a selection of one or more desired online content feeds from the one or more available online content feeds presented to the person; and
prior to delivery of the information handling system to an end user of the information handling system, preconfiguring the information handling system to receive the one or more desired online content feeds.

10. A method according to claim 9, wherein the popularity index for each of the one or more available online content feeds is determined based at least on a number of subscribers to the particular online content feed.

11. A method according to claim 9, wherein the popularity index for each one of the one or more available online content feeds is determined based at least on:
one or more demographic characteristics of the person; and
a number of subscribers to the particular online feed that possess the one or more demographic characteristics.

12. A method according to claim 11, wherein the one or more demographic characteristics include at least one of the person's age, sex, race, nationality, and geographic location.

13. A method according to claim 9, wherein the popularity index for each one of the one or more available online content feeds is determined based at least on:
one or more characteristics of the information handling system; and
a number of subscribers to the particular online feed that have ordered an information handling system possessing the one or more characteristics.

14. A system for configuring an information handling system for online content feeds, comprising:
a configuration server configured to present, during an ordering process for an information handling system, one or more available online content feeds to a person ordering an information handling system, the one or more available online content feeds presented in accordance with a popularity index for each of the one or more available online content feeds;
a user device configured to communicate, during the ordering process, a selection of one or more desired online content feeds for which the person desires to have the information handling system preconfigured to receive; and
a production module configured to preconfigure, prior to delivery of the information handling system to an end user of the information handling system, the information handling system to receive the one or more desired online content feeds.

15. A system according to claim 14, wherein the popularity index for each of the one or more available online content feeds is determined based at least on a number of subscribers to the particular online content feed.

16. A system according to claim 14, wherein the popularity index for each one of the one or more available online content feeds is determined based at least on:
one or more demographic characteristics of the person; and
a number of subscribers to the particular online feed that possess the one or more demographic characteristics.

17. A system according to claim 16, wherein the one or more demographic characteristics include at least one of the person's age, sex, race, nationality, and geographic location.

18. A system according to claim 14, wherein the popularity index for each one of the one or more available online content feeds is determined based at least on:
one or more characteristics of the information handling system; and
a number of subscribers to the particular online feed that have ordered an information handling system possessing the one or more characteristics.

19. A system according to claim 14, further comprising a online content feed server configured to receive the selection of the one or more desired online content feeds and update the popularity index for each of the one or more available online content feeds based at least one the selection.

20. A system according to claim 14, further comprising a online content feed server configured maintain the popularity index for each of the one or more available online content feeds based at least on a number of subscribers to the particular online feed that possess one or more demographic characteristics.
